(19) United States
(12) Patent Application Publication
(10) Pub. No.: US 2022/0031437 A1
(43) Pub. Date: Feb. 3, 2022

(54) APPARATUS AND METHOD FOR DENTAL CLEANING

(71) Applicant: Nordent Manufacturing, Elk Grove Village, IL (US)

(72) Inventors: Tim Irwin, Orland Park, IL (US); Tom Stopka, St. Charles, IL (US)

(21) Appl. No.: 16/942,128

(22) Filed: Jul. 29, 2020

(51) Int. Cl. A61C 17/34; A61C 17/22

(52) U.S. Cl. CPC A61C 17/34; A61C 17/225; A61C 17/221

(57) ABSTRACT

A dental tool can include a handpiece with a working tip. The working tip can be driven by the handpiece to oscillate. The oscillations have a rate of less than 500 cycles per second, in order to reduce or eliminate the generation of aerosols created by oscillation of the working tip. The working tip can include a set of teeth to remove calculus, stains, or plaque from a tooth surface, or can include an abrasive surface or coating, or a prophy cup.

### TECHNICAL FIELD OF THE INVENTION

This disclosure generally relates to a method and apparatus for cleaning teeth, removing calculus from teeth, and periodontics. More specifically, the disclosure relates to a method and apparatus for dental work which oscillates at a speed to avoid, minimize, or eliminate the generation of aerosols during use.

### BACKGROUND

Dentists, technicians, orthodontists, and other dental professionals utilize tools to clean and work on patients' teeth and other oral areas. Hand instrument use by dental professionals has decreased, as the speed and ease of ultrasonic scalers helps provide comfort efficiency to such dental professionals. Hand, wrist, or forearm strain, or even carpal tunnel syndrome can be common in dental professionals using hand instruments. Vibrating or oscillating tools are becoming common for removal of calculus or plaque, as an alternative to uncomfortable or less efficient hand instruments. However, such tools often generate aerosols, which can transmit viruses, disease, or bacteria from the patient to the dental professional.

### BRIEF SUMMARY

Aspects of the disclosure herein relate to a dental tool comprising: a body extending between an attachment end and a working end: a working tip mounted to the body at the working end, the working tip configured to be driven to oscillate; a set of teeth extending from the working tip, configured to be oscillated by the working tip to remove or clean material from a dental patient.

A working tip for a dental tool, the working tip comprising: a working surface configured to be oscillated to remove or clean material from a dental patient; wherein a rate of oscillation for the working surface is five-hundred oscillations per second or less.

A method of removing calculus, stains, or plaque from a tooth surface, the method comprising: oscillating a working tip at a rate of oscillation that is less than five-hundred cycles per second.

### BRIEF DESCRIPTION OF THE DRAWINGS

In the drawings:

FIG. 1 is a view illustrating a handpiece for connecting and driving a tip tool.

FIG. 2 is a view of one exemplary tip tool attachable to the handpiece of FIG. 1, and including a working tip.

FIG. 2A is a front view of an end of the working tip of FIG. 2 showing vertical teeth.

FIG. 2B is a side view of the working tip of FIG. 2.

FIG. 2C is a top view of the working tip of FIG. 2.

FIG. 3 is a view of another exemplary tip tool attachable to the handpiece of FIG. 1, and including a diamond coated working tip.

FIG. 3A is a front view of the working tip of FIG. 3.

FIG. 3B is a side view of the working tip of FIG. 3.

FIG. 4 is a view of another exemplary tip tool attachable to the handpiece of FIG. 1, showing vertical teeth.

FIG. 5 is a view of another exemplary tip tool attachable to the handpiece of FIG. 1, showing vertical teeth.

FIG. 6 is a view of another exemplary tip tool attachable to the handpiece of FIG. 1, showing vertical teeth.

FIG. 7 is a view of another exemplary tip tool with a head attachable to the handpiece of FIG. 1.

FIG. 7A shows a side view of a prophy cup which can be attached to the head of FIG. 7.

FIG. 7B shows a bottom view of the prophy cup of FIG. 7A, including a concavity with a set or ribs and a set of fins.

FIG. 8 shows a flow chart for a method of removing calculus or other material from a tooth surface.

### DETAILED DESCRIPTION

Aspects of the present disclosure relate to a tool for cleaning teeth or for other dental, orthodontic, or periodontic procedures. More specifically, the disclosure relates to a cleaning tool that can effectively clean teeth with vibrating or oscillating features, without generating aerosols. In one aspect, oscillations can be limited to 500 cycles per second or less in order to reduce or eliminate aerosols generated by the oscillations.

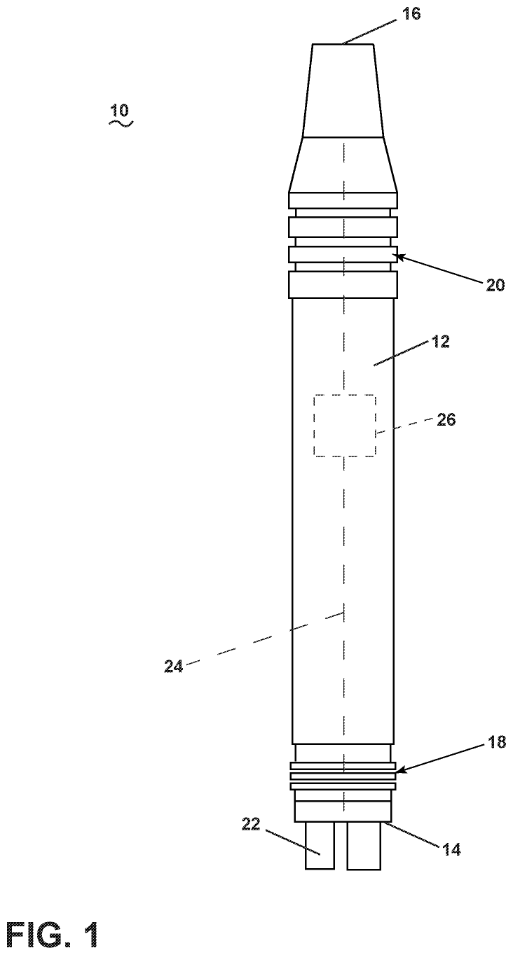

For purposes of description related to the figures, the terms “upper,” “lower,” “right,” “left,” “rear,” “front,” “vertical,” “horizontal,” and derivatives thereof shall relate to the invention as oriented in FIG. 1. However, it is to be understood that aspects of the present disclosure may assume various alternative orientations, except where expressly specified to the contrary. A ‘set’ as used herein can include any number of elements, including only one.

FIG. 1 shows a handpiece 10. The handpiece 10 includes a body 12 extending between a first end 14 and a second end 16. The body 12 includes a cylindrical shape, in one non-limiting example, with a first set of grip features 18 and a second set of grip features 20 provided near each end 14, 16, while the particular shape and grip for the handpiece is not germane to the invention.

The first end 14 includes a set of connectors 22. The set of connectors 22 can be utilized to connect the handpiece 10 to a drive system 24, shown schematically, including a motor 26 or other mechanical driver or system to convert energy into work. Such a drive system 24 can be utilized, via the handpiece 10, the drive a tip tool (discussed in detail below) attached to the handpiece 10. In one example, the drive system 24 can include air, such as powered by compressed air, which can be converted into mechanical energy by the motor 26 and provided to a tip tool via the drive system 24. In another example, the drive system 24 can be electrical, such as utilizing electrical energy provided to a motor and converting the electrical energy into mechanical work to drive a tip tool attached to the second end 16. Additionally, battery or portable power systems are contemplated, while any suitable drive system can be utilized.

The second end 16 can be configured to receive a tip tool, such as those described herein. The second end 16 can also be mechanically configured to couple to and drive the tip tool via the drive system 24.

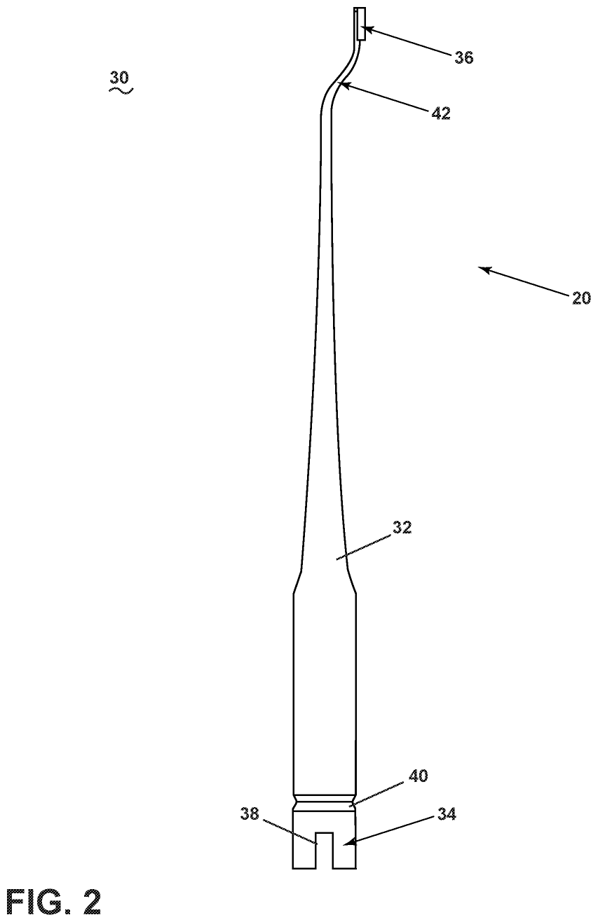

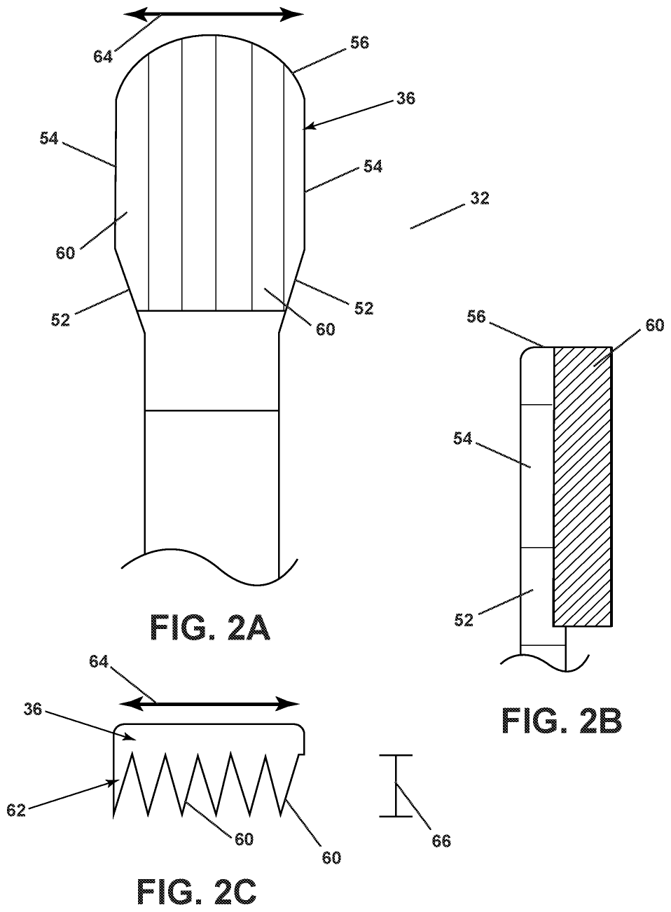

Referring to FIG. 2, a tip tool 30, which can be attached to the handpiece 10 of FIG. 1, includes a body 32 extending between an attachment end 34 and a working tip 36. The attachment end 34 can include an alignment slot 38 and a quick release groove 40. The alignment slot 38 can provide for proper attachment of the tip tool 30, and can ensure that the features of the drive system 24 properly connect between the tip tool 30 and the handpiece 10. The quick release groove 40 can provide for securing attachment of the tip tool 30 to the handpiece 10, while permitting easy disconnection among the tip tool 30 and the handpiece 10 for changing tip tools 30. The body 32 includes a generally cylindrical or conical shape, while including a curved portion 42 just prior to the working tip 36, as is common in dental equipment to facilitate reaching portions of a patient's teeth or oral cavity.

In operation, the tip tool 30 can be vibrated by the handpiece 10, such that the entire tip tool 30 oscillates. Oscillation of the tip tool 30 provides for oscillation of the working tip 36, which can provide for removing material from a tooth surface.

Referring now to FIG. 2A, the working tip 36 includes a pair of angled side walls 52 diverging from the connector 50 to widen the working tip 36. A pair of linear side edges 54 extend from the angled side walls 52 to a rounded tip 56. Such an arrangement provides for no sharp corners around the edges of the working tip 36, which may otherwise hurt a patient or cause discomfort.

Referring now to FIGS. 2B and 2C, the working tip 36 includes a set of teeth 60. The teeth 60 are arranged in a row 62, with each tooth 60 extending parallel to one another. The teeth 60 extend longitudinally, relative to the longitudinal extent of the body 32 or the tip tool 32, while the teeth 60 can also be said to extend vertically, when the tip tool 30 is set on its attachment end 34. It should be understood, however, that the tip tool 36 can have other arrangements or geometries for the sets of teeth 60, as different types of tooth patterns or shapes may be beneficial to different types or intended uses for the particular tip tool 30. Non-limiting examples of types of tooth patterns or shapes can include, vertical, horizontal, diagonal, linear, angled, curved, random, pointed, conic, discrete, jagged, unique, or any combination thereof. Further still, it is contemplated that the sets of teeth 60 may include differing zones of tooth patterns, such as, in one non-limiting example, that the teeth 60 may be arranged vertically on one half of the working tip 36, while the teeth 60 are arranged horizontally (perpendicular to the vertical arrangement) on the remaining half of the working tip 36.

In FIG. 2B, one can appreciate that the side-view of the teeth 60 is squared. As shown in FIG. 2C, the teeth 60 include an isosceles-triangular profile, where the two equal sides extend to the tip as the outward-most extent of the teeth 60. Similarly, as discussed above, different shapes, patterns, and geometries are contemplated, as well as different, varying, or unique profiles generated thereby. In one example, the teeth 60 can be 0.025 millimeters (mm) tall, meaning that a depth 66 of the teeth 60 can be 0.025 mm. Additional, different, or varying sizes are similarly contemplated. Furthermore, it is contemplated that different sizes or arrangements for teeth 60 can be tailored to the amount of material needed to be remove from a tooth surface. For example, the particular teeth can be tailored to remove heavy or tenacious calculus, stain, or even residual cement from a tooth surface.

In operation, the working tip 36 can be vibrated or otherwise oscillated. For example, the oscillations could include where the working tip 36 oscillates left-to-right, as indicated by arrow 64, such that the teeth 60 can be used to scrape along a patient's tooth surface. Additional vibrations or oscillations are contemplated, such as up-and-down or circular in non-limiting examples. In one example, the speed of the oscillations can be set such that no more than five-hundred (500) cycles per second, where a cycle can be one period of the oscillation. Such an operational speed limit provides for minimizing, reducing, or even wholly eliminating the generation of aerosols during operation of the tip tool 30.

In comparison, typical oscillating dental tools operate at sonic or ultrasonic speeds, such as 3,000-9,000 cycles per second or 25,000-30,000 cycles per second, respectively. At such speeds, these tools can generate significant heat. Often, these tools will include a water supply in order to cool the tools and the heat generated by the friction of the oscillations contacting a tooth surface. As one can appreciate, such operational speeds with the presentation of water, or any other liquid including saliva, can readily generate aerosols, which may provide for the airborne transmission of viruses, disease, sicknesses, material, or bacteria from the patient to a professional, as well as others within the vicinity. The five-hundred cycles or less speed utilized by the working tip 36 disclosed herein can reduce or eliminate the creation of such aerosols, thus minimizing, reducing, or eliminating the opportunity of transmission of viruses, diseases, sicknesses, or bacteria to be passed from the patient to the professional via use of the dental cleaning tools. It should be understood that tools operating at sonic or ultrasonic speeds generate aerosols, which can carry viruses or disease in an airborne manner, which increases the opportunity for transmission. The tools as described herein are intended to operate without generation of aerosols.

More specifically, during the COVID-19 pandemic, the Center for Disease Control (CDC) and the Occupational Safety and Health Administration (OSHA) have indicated that dental tools that generate aerosols are not to be used. Therefore, a dental tool that can operate without generating aerosols can be desirable. The particular dental tool as described herein, when operating at 500 oscillation cycles per second, does not generate aerosols.

It should be appreciated that other oscillating speeds are contemplated herein. For example, the oscillating speed can be 1000 cycles per second or less, or any suitable operational speed that does not generate enough heat to require liquid cooling, or does not operate at a rate fast enough to generate aerosols. Such a rate can be tailored to the particular tool or the particular procedure. For example, one dental tool may include a material that generates significant heat at 700 cycles per second, while another generates significant heat at 500 cycles per second, with neither tool generating aerosols at either speed. Thus, the rate of oscillations for the first dental tool can be 700 cycles per second or less, while the rate for the second can be 500 cycles per second or less. Similarly, the type of material may be more or less effective at differing oscillation rates. For example, steel may be utilized at 500 cycles per second, but a diamond coated tool may be utilized at 300 cycles per second. The aforementioned should be understood as exemplary only, and it should be appreciated that the rates as discussed above are intended to illustrate that particular rate of oscillations can vary, based upon the tool being used, as long as aerosols are not generated during use, and that the examples discussed above are merely by way of example only.

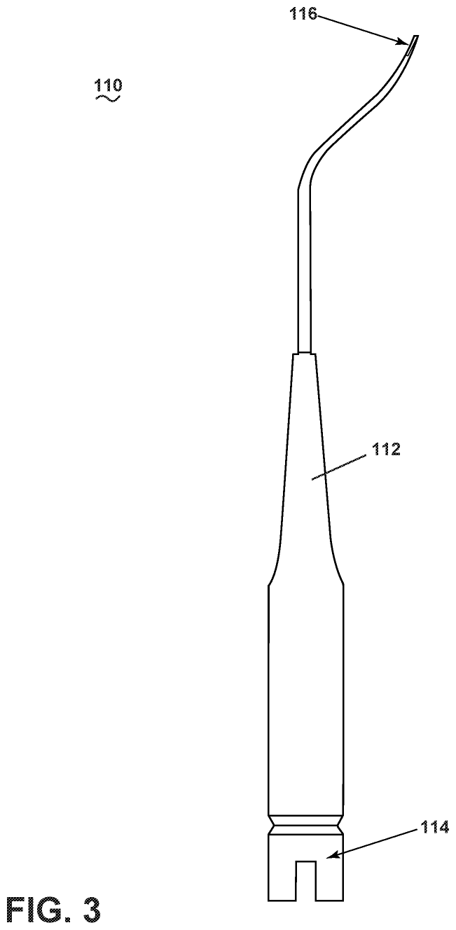

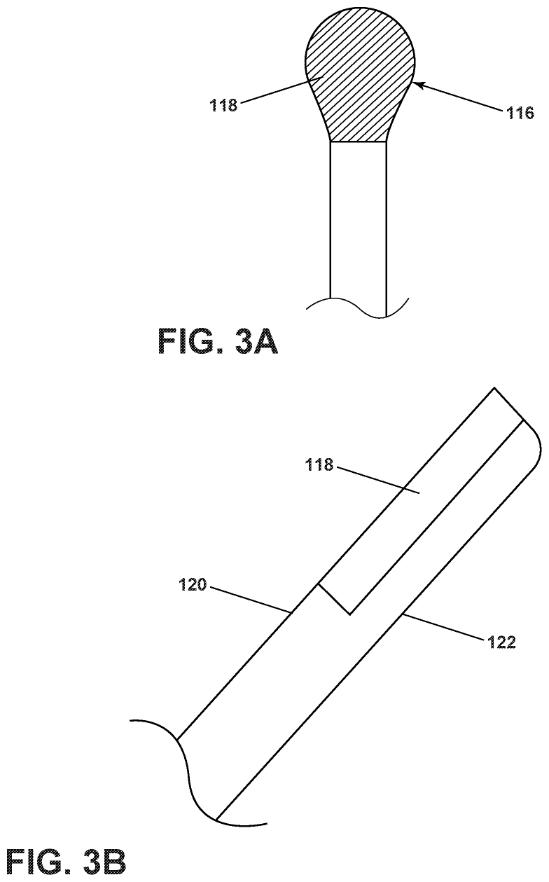

Referring to FIG. 3, another exemplary tip tool 110 is shown. The tip tool 110 can be similar to the tip tool 30 of FIGS. 1-2C, containing a body 112, an attachment end 114, and a working tip 116. It should be appreciated that the tip tool 110 can include the same features as that of FIGS. 1-2C, but need not include all of the same features. The discussion herein will be limited to the differences between the two.

Referring now to FIG. 3A, the working tip 116 is enlarged, having a rounded profile, while any suitable profile shape or geometry is contemplated. Such a rounded profile, provides for reducing pain or discomfort for the patient during use. As indicated by the diagonal lines, the working tip 116 can include an abrasive coating 118, which is adapted to operate to clean teeth at oscillations of 500 oscillations per second or less. In one example, the abrasive coating 118 can be an abrasive diamond coating. It is further contemplated that the abrasive coating 118 can be any coating having a hardness suitable to remove calculus from teeth.

Referring to FIG. 3B, the abrasive coating 118 can be provided on a front face 120 of the tip tool 110, while the body 112 can extend along a rear face 122. As such, the abrasive coating 118 portion is limited to just the front face 120. It should be appreciated that other arrangements are contemplated, and the abrasive coating 118 need not be limited to a front face arrangement.

The abrasive diamond coating 118 can be utilized to remove light calculus, sheet calculus, or stain. Additionally, the abrasive coating can be utilized to smooth rough tooth surfaces.

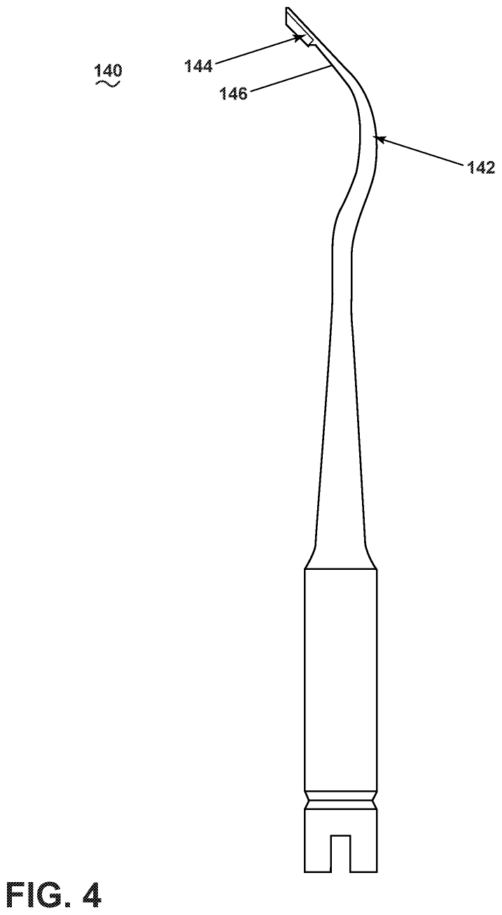

FIGS. 4-6 show three different embodiments for tip tools with working tips, which can include the working tip 36 of claims 1-2C, or the abrasive coating 118 of FIGS. 3-3B, or even a combination thereof. FIG. 4 shows a tip tool 140 having a bend 142 extending toward a working tip 144. The working tip 144 is provided on an underside 146 of the tip tool 140, relative to the curvature of the bend 142.

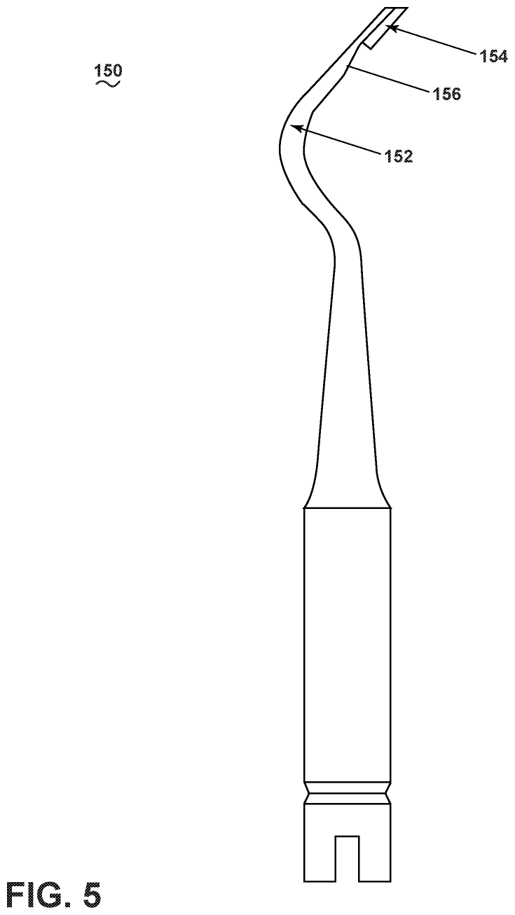

FIG. 5 shows another exemplary tip tool 150 having a bend 152 with a greater curvature than that of the bend 142 of FIG. 4. A working tip 154 is positioned on an underside 156 of the tip tool 150, relative to the bend 152.

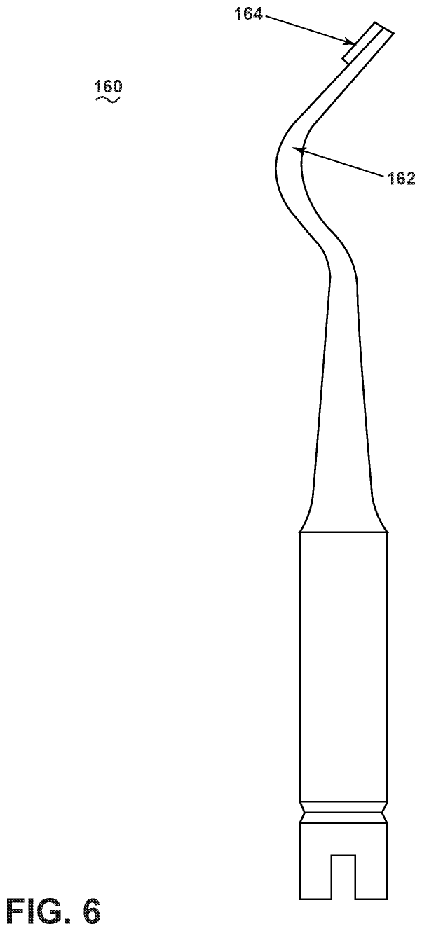

FIG. 6 shows yet another tip tool 160 having a bend 162. A working tip 164 is provided on the outer or exterior surface 166 of the tip tool 160, relative to the curvature of the bend 162, in contrast to that of FIGS. 4 and 5.

From FIGS. 4-6, one can appreciate that the working tips as described herein can be incorporated into tip tools, dental tools, or other oscillating tools with any suitable structure for the tip tool. Thus, the working tips as described herein can be incorporated into and utilized with a multitude of types of dental tools, with any suitable shape, size, geometry, or orientation.

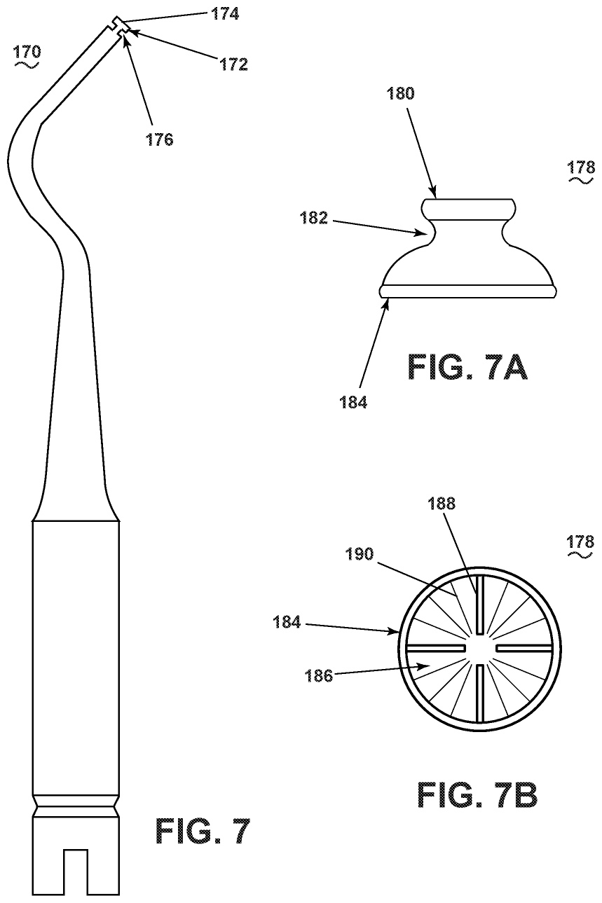

FIG. 7 includes another exemplary tip tool 170, similar to those described in FIGS. 2-6. The tip tool 170 includes a tip end 172 having a head 174. The head 174 includes an annular channel 176 configured to retain an element that attaches to the tip tool 170.

FIG. 7A depicts a cup 178 for attachment to the head 174 of the tip tool 170. The cup 178, for example, can be a prophy cup for polishing a tooth surface with an abrasive paste. The cup 178 can include an attachment end 180 with a neck 182, where the neck 182 can attach to the head 174 at the channel 176. The cup 178 further includes a concavity end 184, opposite the attachment end 180.

FIG. 7B shows a bottom view of the cup 178 and the concavity end 184 of the cup 178, which defines a concavity 186. A set or fins 188 can extend into the concavity 186 and a set of ribs 190 are provided on the walls of the cup 178 within the concavity 186.

In operation, an abrasive paste, like oral polish, can be provided into the concavity 186. The tip end 172 or working tip can be oscillated by the tip tool 170, such that the cup 178 is oscillated as well when attached to the tip tool 170. Oscillation of the cup 178 can be utilized to polish a tooth surface with the abrasive paste. The fins 188 and ribs 190 can be one example of an interior design for the cup 178, while other features or geometries are contemplated. Exemplary features or geometries can include bars, ribs, fins, bumps, brushes, spikes, knobs, knurls, rough portions, or combinations thereof. Features of the cup 178 may be made of a resilient material, such as rubber, which can be utilized to polish a tooth surface without requiring excessive oscillation rates or speeds. The prophy cup can be utilized to polish supragingival enamel, or even dental restorations, or prostheses.

The oscillations of the cup 178, for example, can be 500 cycles per second or less, or another oscillation rate such that oscillation of the tip end 172 drives the cup 178 at a speed that no aerosols are generated, or that any splatter otherwise generated by the oscillation of the abrasive paste is reduced, minimized, or eliminated. Other, typical polishing tools rotate at high speeds. Rotating polishing tools can readily generate aerosols or splatter, as the inertial forces can throw liquid, debris, or other material readily from the patient. The use of an oscillating tool, such as the one described herein, at speeds that are less than 500 oscillations per second, can reduce or eliminate the occasion for aerosol or splatter generation during use.

Alternatively, it is contemplated that the polishing tip need not be a rubber cup, but can be another element, such as a knob, brush, or other feature that can be oscillated and utilized to polish a tooth surface with an abrasive paste. Another non-limiting example can include a surface having a plurality of concavities, with or without interior features, configured to carry the abrasive paste.

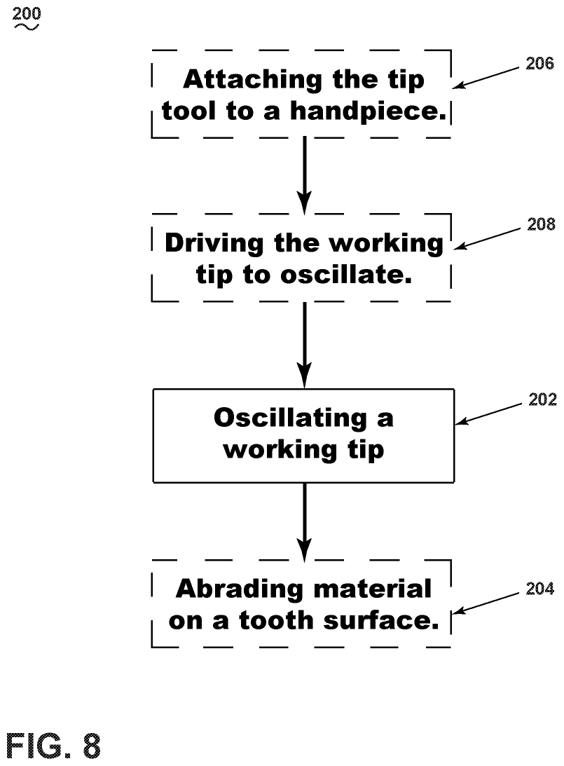

Referring now to FIG. 8, a method 200 of removing calculus, stains, or plaque, or any other material from a tooth, dental, orthodontical feature can include at 202, oscillating a working tip at a rate of oscillation that is less than five-hundred cycles per second. Such oscillations can be in the form of vibrations of the working tip. Vibrations can include, in non-limiting examples, a side-to-side motion, an up-and-down motion, or a circular motion in an oscillating manner, or any combination thereof. Such oscillations can include a cycle, wherein one cycle is one completion of any one oscillation. As such five-hundred cycles per second or less than can include five-hundred oscillations per second or less.

Such an oscillating speed can provide for the removal of calculus, stains, plaque or other material from a tooth without generating an aerosol. It is desirable to provide such cleaning without generating an aerosol, as aerosolized material can carry viruses, disease, bacteria, or other material through the air to a dental professional, or other person within the vicinity of the dental professional. Thus, the rate of oscillations at 500 cycles or less can provide for assisting in cleaning teeth without generating aerosols, which decreases or eliminates the opportunity for airborne transmission of viruses, disease, bacteria, or other material during a dental procedure. As such, it should be understood that the rate of oscillations can be critical to the invention, such that the particular rate does not generate aerosols. Such a rate, in one non-limiting example, can be a rate of 500 cycles per second or less.

Furthermore, the method 200 can optionally include, at 204, abrading calculus, stains, or plaque form a tooth surface with the working tip oscillating against the tooth surface. While the working tip is oscillating at the rate of 500 cycles or less, the tip tool can be used to abrade calculus, stains, plaque, or other material from the tooth surface. While using the tip tool, the oscillating working tip provides for abrading the calculus, stains, plaque or other material without generating an aerosol, by oscillating at 500 cycles per second or less.

At 206, the method 200 can optionally include, attaching a tip tool, including the working tip, to a handpiece. The method 200 can include where a tip tool, or a set of tip tools, with each including a working tip, can be connected to a handpiece that can provide for driving the oscillations of the working tip. The tip tools as described herein can be included as a set of dental tools, with each tool including the working tip, such that a dental professional can quickly and easily interchange working tips, as may be desired for use on different portions or areas of a patient's mouth or teeth.

At 208, the method 200 can further include driving the oscillations of the working tip with the handpiece. The handpiece can include a system for driving the oscillations, such as utilizing pressurized air or electrical energy to drive a motor to provide for oscillating the working tip. A drive train, or other mechanical system, can be provided in the tip tool for providing the driving energy or work to the working tip to drive the oscillations. The method 200 can further include that the rate of oscillations is slow enough such that oscillation of the working tip does not generate an aerosol.

It should be understood that the description of the method 200 or the order shown in FIG. 7 are not limiting, and the order can be changed, or other elements can be added or removed from the method. The portions of the method 200 shown in broken line can be optional.

It should be appreciated that the disclosure provided herein provides a dental tool for working on a patient's mouth or teeth, as well as a method thereof. The dental tool and method provide for working on a patient with an oscillating tool without generating an aerosol. The oscillation rate is critical to reducing or preventing the generation of aerosols, as current solutions in the industry oscillate at a high rate that generates aerosols, which can facilitate the transmission of viruses, disease, bacteria, or other material. Therefore, it should be appreciated that the dental tool herein provides for reducing or eliminating the opportunity for transmission of viruses, disease, bacteria, or infection during dental procedures, which can benefit safety and health of dental professionals, as well as their patients. Furthermore, the disclosure provided herein provides for a dental tool to easily and efficiently clean and treat a patient, without generating aerosols. Such provides for improved and increased comfort for the dental professional, as well as improved cleaning of teeth, which can otherwise be difficult with the use of hand instruments alone, which can cause strain, discomfort, pain, or even occupational injury to the dental professional through extended use of such hand instruments. This is done without the generation of aerosols.

To the extent not already described, the different features and structures of the various embodiments of the present disclosure may be used in combination with each other as desired. For example, one or more of the features illustrated and/or described with respect to one of the systems or a component thereof can be used with or combined with one or more features illustrated and/or described with respect to the other of the system or component thereof. That one feature may not be illustrated in all of the embodiments is not meant to be construed that it cannot be, but is done for brevity of description. In one non-limiting example, the set of teeth 60 can be incorporated with the abrasive coating 118, to improve effective removal of calculus from a patient. Thus, the various features of the different embodiments may be mixed and matched as desired to form new embodiments, whether or not the new embodiments are expressly described. Such should be understood to be within the scope of one having ordinary skill in the art based upon the disclosure provided herein.

While aspects of the present disclosure have been specifically described in connection with certain specific embodiments thereof, it is to be understood that this is by way of illustration and not of limitation. Reasonable variation and modification are possible within the scope of the forgoing disclosure and drawings without departing from the spirit of the present disclosure which is defined in the appended claims.

What is claimed is:

1. A dental tool comprising:
a body extending between an attachment end and a working end:
a working tip mounted to the body at the working end, the working tip configured to be driven to oscillate;
a set of teeth extending from the working tip, configured to be oscillated by the working tip to remove or clean material from a dental patient.

2. The dental tool of claim 1 further wherein the working tip is oscillated at a rate that is less than five-hundred cycles per second.

3. The dental tool of claim 2 wherein the rate at which the working tip is oscillated does not generate an aerosol.

4. The dental tool of claim 1 wherein each tooth of the set of teeth includes a peak configured to contact a tooth surface.

5. The dental tool of claim 4 wherein each tooth of the set of teeth includes a triangular profile.

6. The dental tool of claim 5 wherein the triangular profile is an isosceles-triangular shape.

7. The dental tool of claim 1 wherein the set of teeth are formed as an abrasive surface.

8. The dental tool of claim 7 wherein the abrasive surface is a diamond coating.

9. The dental tool of claim 1 wherein the working tip is driven to oscillate with air pressure.

10. The dental tool of claim 1 wherein working tip is made from stainless steel and coated with titanium nitride.

11. A working tip for a dental tool, the working tip comprising:
a working surface configured to be oscillated to remove or clean material from a dental patient;
wherein a rate of oscillation for the working surface is five-hundred oscillations per second or less.

12. The working tip of claim 11 wherein the rate of oscillation does not generate an aerosol.

13. The working tip of claim 11 wherein the working surface includes a set of teeth.

14. The working tip of claim 11 wherein the working surface includes an abrasive coating.

15. The working tip of claim 11 wherein the working surface includes a rounded tip.

16. A method of removing calculus, stains, or plaque from a tooth surface, the method comprising:
oscillating a working tip at a rate of oscillation that is less than five-hundred cycles per second.

17. The method of claim 16 further comprising abrading calculus, stains, or plaque from the tooth surface with the working tip oscillating against the tooth surface.

18. The method of claim 16 further comprising attaching a tip tool, including the working tip, to a handpiece.

19. The method of claim 18 further comprising driving the oscillations of the working tip with the handpiece.

20. The method of claim 16 wherein the rate of oscillation is slow enough such that an aerosol is not generated by the oscillations.
